(19) United States
(12) Patent Application Publication
(10) Pub. No.: US 2026/0091655 A1
(43) Pub. Date: Apr. 2, 2026

(54) Protective Assembly for a Windshield

(71) Applicant: Infonet Corp. dba Summit Products, Inc., Altoona, IA (US)

(72) Inventors: Albert Marasco, Altoona, IA (US); Brad Stricker, Altoona, IA (US)

(73) Assignee: Infonet Corp. dba Summit Products, Inc., Altoona, IA (US)

(21) Appl. No.: 19/330,450

(22) Filed: Sep. 16, 2025

Related U.S. Application Data
(60) Provisional application No. 63/702,244, filed on Oct. 2, 2024.

(51) Int. Cl. B60J 1/04; B60J 10/70

(52) U.S. Cl. CPC B60J 1/04; B60J 10/70

(57) ABSTRACT

A protective assembly for preventing damage to a UTV or similar windshield. A frame is adhered to the inner surface of the windshield. A rubber gasket is adhered to the frame such that the rubber gasket extends around an outer perimeter of the frame and an outer perimeter of the windshield.

### CROSS-REFERENCE TO RELATED APPLICATIONS

This application claims priority to U.S. Provisional Patent Application No. 63/702,244, filed on Oct. 2, 2024, the entirety of which is hereby incorporated herein by reference.

### FIELD OF THE INVENTION

The disclosure relates generally to a protective assembly for a windshield. In particular, the disclosure relates to a frame and gasket assembly suitable for mounting onto the windshield of a utility terrain vehicle.

### BACKGROUND OF THE INVENTION

Various utility terrain vehicles (“UTVs”) are currently available. The windshield of a UTV is typically formed from a large piece of glass that can be mounted within a frame opening in the front of the UTV. In some cases, the windshield of a UTV can be raised to an open position or lowered to a closed position pivoting around one or more hinges at the top of the windshield and clamping closed using a clamping handle that is generally located at the bottom center of the windshield. In other cases, a UTV windshield is held in place by clamps, and cannot be opened. The finished edges of the windshield glass are typically exposed with no protective material attached to the edges of the glass. As such, the exposed edges of the glass are vulnerable to damage when the windshield is raised. When the windshield is lowered, or for windshields that cannot be opened, the vehicle frame provides some protection to the windshield; however, the unprotected edges of a vehicle windshield leave the windshield prone to damage even in the closed position as breakage often occurs when the UTV travels over rough or uneven terrain. Therefore, a protective assembly for a vehicle windshield is desired.

### SUMMARY OF THE INVENTION

In accordance with various embodiments of the invention, a protective assembly for a windshield is provided. In one embodiment, a protective assembly for a windshield comprises a frame. The frame may comprise a top wall, a bottom wall, a first side wall, and a second side wall that define an opening in the frame. The frame may further comprise an inner surface and an outer surface wherein the outer surface of the frame is attached to an inner surface of the windshield. The top wall, bottom wall, first side wall, and second side wall of the frame may be continuous such that the inner surface and outer surface of the frame are seamless. The outer surface of the frame may be attached to the inner surface of the windshield using an adhesive. In one embodiment, the outer perimeter of the windshield may align with the outer perimeter of the frame. Alternatively, the outer perimeter of the frame may extend beyond the outer perimeter of the windshield. A rubber gasket is attached to the frame such that the rubber gasket extends around an outer perimeter of the frame and an outer perimeter of the windshield. The rubber gasket may attach to the inner surface of the frame using an adhesive. The rubber gasket may comprise a cap configured to overlap both the windshield and a frame of a vehicle on which the windshield is installed. The rubber gasket may comprise an enlarged section extending between the inner surface of the frame and an inner extent of the rubber gasket which engages the frame of the vehicle. The enlarged section of the gasket may further comprise a vehicle engaging member extending between an outside edge of the enlarged section and an edge of the frame of the vehicle that is adjacent to the outer perimeter of the windshield.

In another embodiment, a method of making a protective assembly for a windshield is provided. A windshield comprising an inner surface and an outer surface is provided. A frame is provided. The frame may comprise a top wall, a bottom wall, a first side wall, and a second side wall that define an opening in the frame. The frame may further comprise an inner surface and an outer surface. A rubber gasket is provided. The rubber gasket may comprise a cap configured to overlap both the windshield and a frame of a vehicle on which the windshield is installed. The outer surface of the frame is attached to the inner surface of the windshield. The rubber gasket is attached to the inner surface of the frame such that the gasket extends around an outer perimeter of the frame and an outer perimeter of the windshield.

### BRIEF DESCRIPTION OF DRAWINGS

FIG. 1 illustrates a cross-sectional view of a protective assembly for a windshield in accordance with one embodiment of the invention.

FIG. 2 illustrates a perspective view of a protective assembly for a windshield in accordance with one embodiment of the invention.

FIG. 3 illustrates detail of a protective assembly for a windshield in accordance with one embodiment of the invention.

FIG. 4 illustrates a protective assembly for a windshield in accordance with one embodiment of the invention.

FIG. 5 illustrates a protective assembly for a windshield in accordance with one embodiment of the invention.

FIG. 6 illustrates a protective assembly for a windshield in accordance with one embodiment of the invention.

FIG. 7 illustrates a protective assembly for a windshield in accordance with one embodiment of the invention.

FIG. 8 illustrates a protective assembly for a windshield in accordance with one embodiment of the invention.

FIG. 9 illustrates a protective assembly for a windshield in accordance with one embodiment of the invention.

FIG. 10 illustrates a protective assembly for a windshield in accordance with one embodiment of the invention.

FIG. 11 illustrates a method for making a protective assembly for a windshield in accordance with one embodiment of the invention.

### DETAILED DESCRIPTION OF THE INVENTION

Some embodiments of the present invention will now be described more fully hereinafter with reference to the accompanying drawings, in which some, but not all, embodiments of the invention are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Some components of the apparatus or method steps are not shown in one or more of the figures for clarity and to facilitate explanation of embodiments of the present invention.

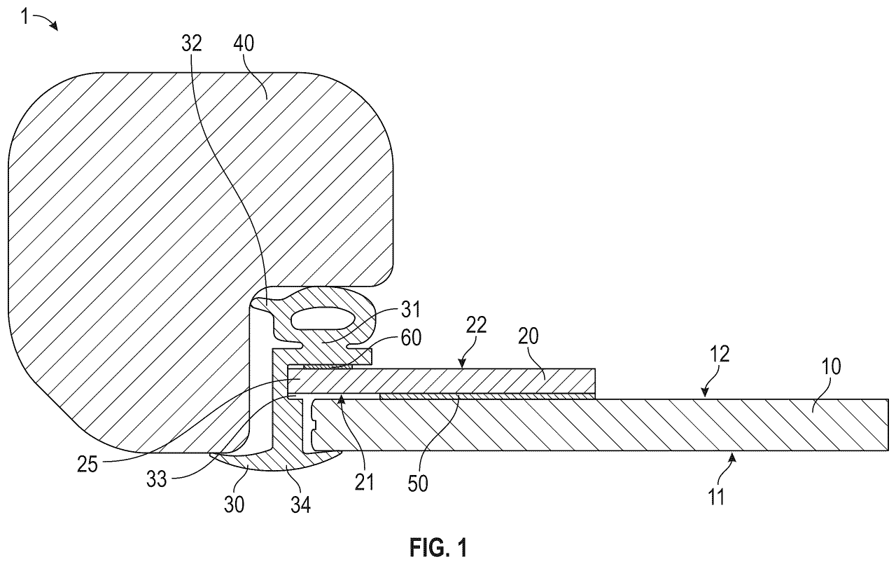

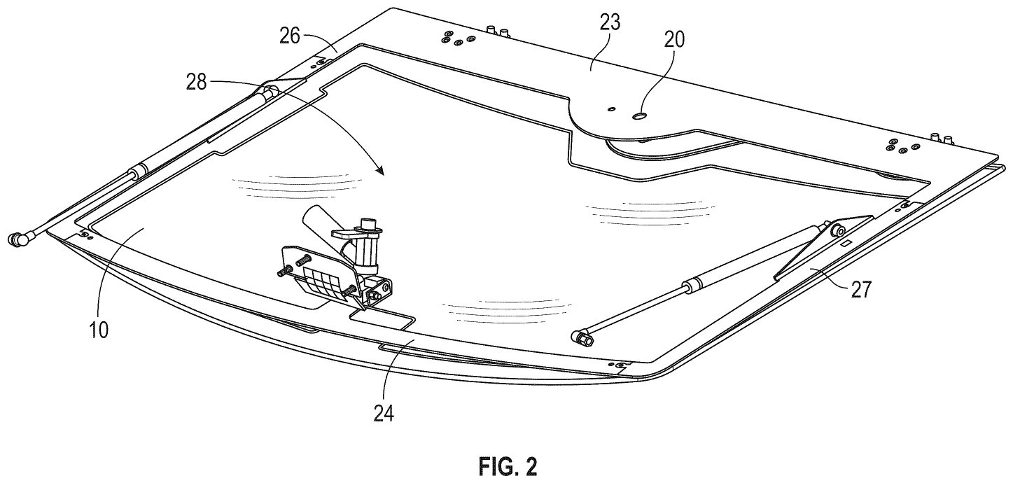

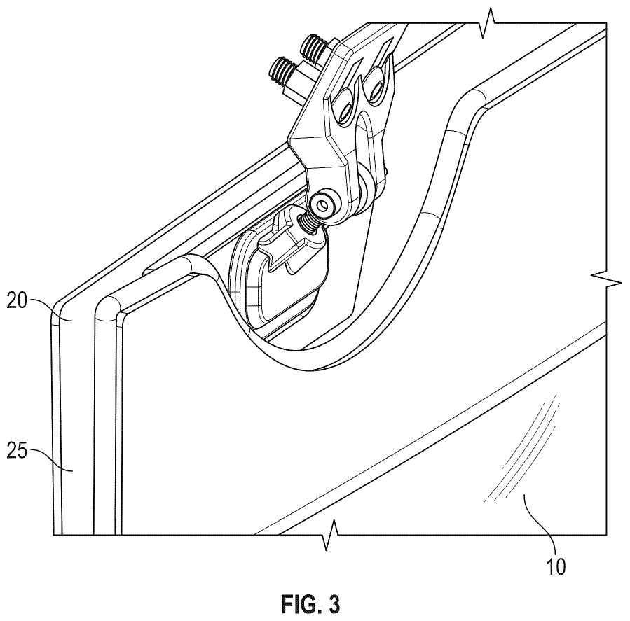

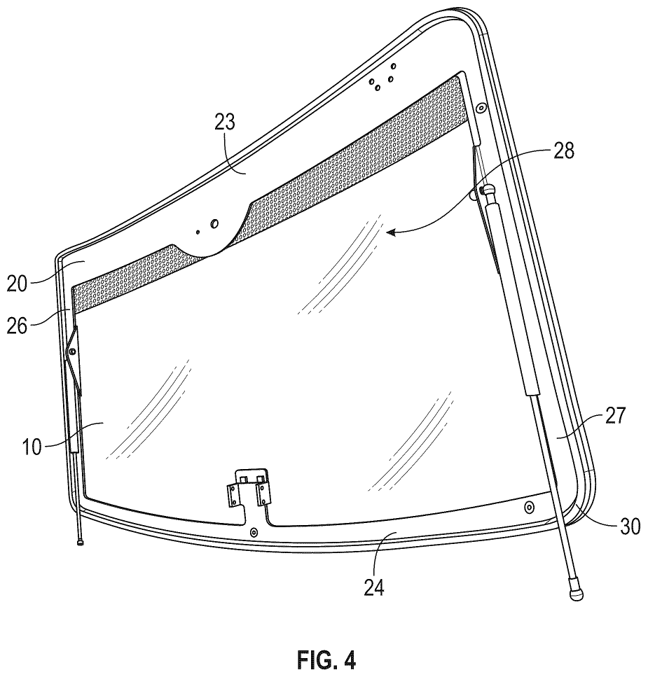

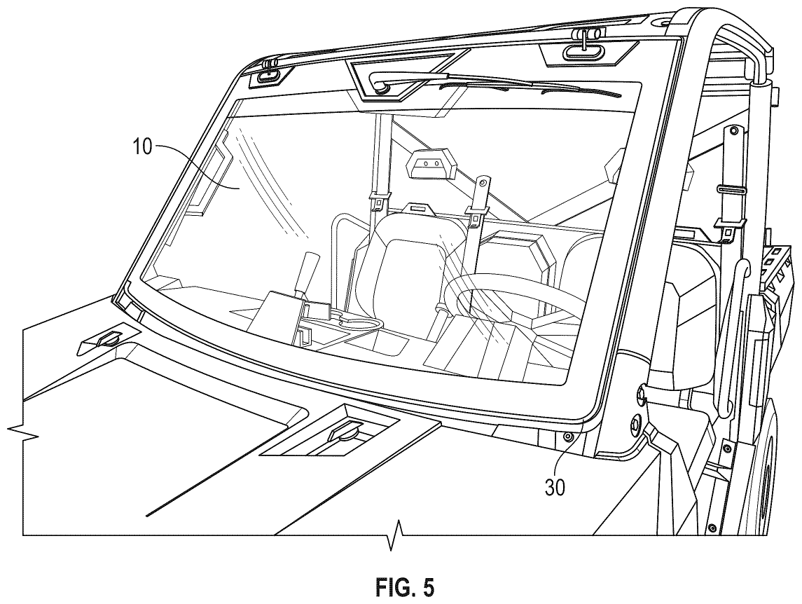

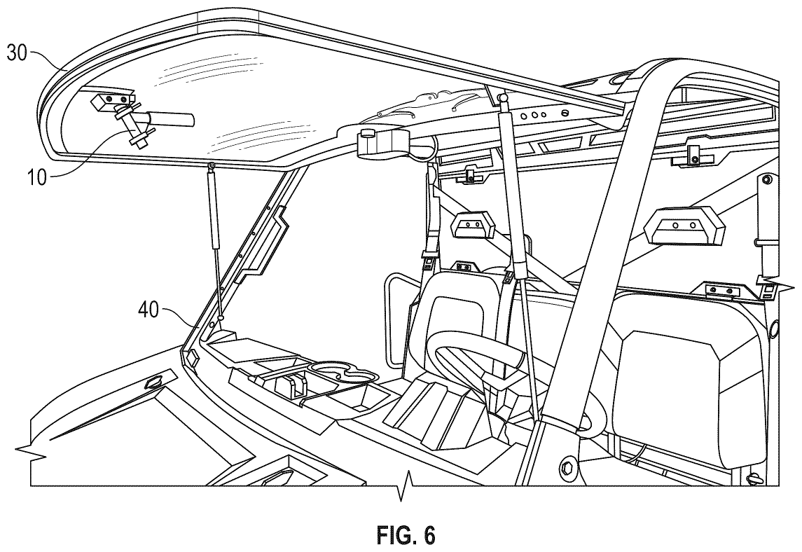

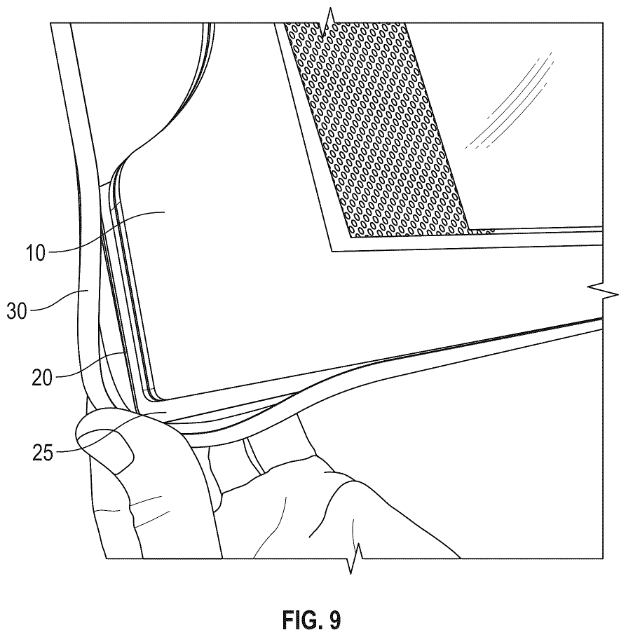

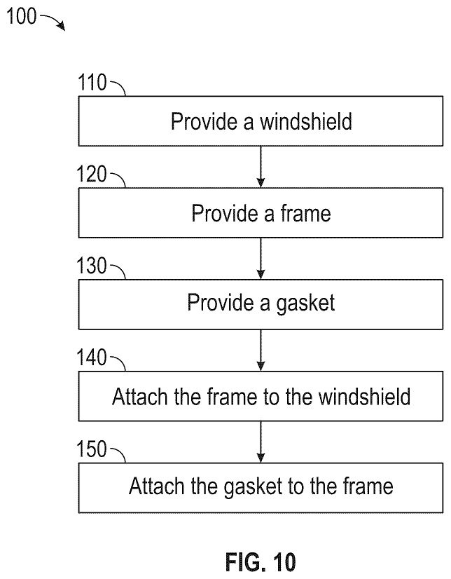

In accordance with one embodiment, FIGS. 1-10 illustrate a protective assembly 1 for a windshield 10. The protective assembly 1 for a windshield 10 may alternatively be referred to as an assembly 1 without departing from the scope of the disclosure. Protective assembly 1 is configured to be installed on a windshield 10 of a vehicle such as a utility terrain vehicle (“UTV”) such that the protective assembly 1 covers the perimeter of the windshield 10, thus protecting the windshield 10 from damage. The protective assembly 1 may comprise a windshield 10 to which a frame 20 is attached. The frame 20 may be attached to the windshield 10 using adhesive 50 or another suitable material or fastener. A gasket 30 is attached to the frame 20, and the gasket 30 surrounds the outer edge of the frame 20 and the edge of the windshield 10. The gasket 30 also engages the frame 40 of the vehicle. The gasket 30 may be attached to the frame 20 using adhesive 60 or another suitable material or fastener. The unique arrangement of the components of the protective assembly 1 allow the protective assembly 1 to be installed on the existing windshield 10 of a vehicle while allowing the windshield 10 to be raised to an open position as shown in FIG. 6 or lowered to a closed position and latched as shown in FIG. 5.

### Windshield 10

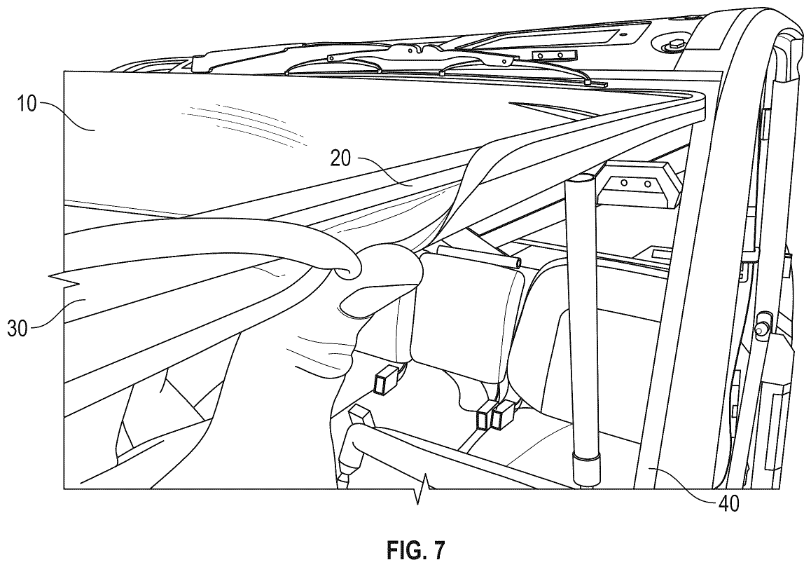

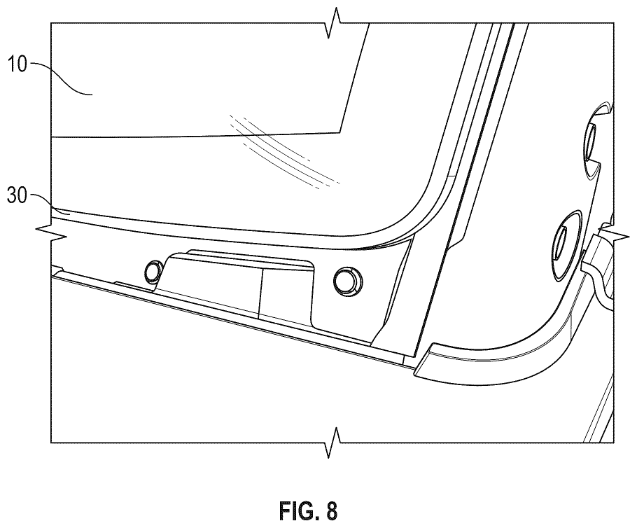

As shown in FIGS. 1-10, the protective assembly 1 includes a windshield 10 for protecting the vehicle's occupants from wind, weather, debris, and other conditions encountered while operating the vehicle. The windshield 10 is typically a piece of safety glass that fits into an opening in the vehicle frame 40; however, plexiglass, e-glass, or any other suitable material may be used. The windshield 10 has a perimeter that is typically treated to have a polished or smooth finish. The windshield 10 has an outer surface 11 comprising the area of glass that faces the exterior of the vehicle and an inner surface 12 comprising the area of glass that faces the interior of the vehicle. The windshield 10 may be flat or generally flat such that outer surface 11 and inner surface 12 of the windshield 10 are each a flat or generally planar surface. Alternatively, the windshield 10 may be curved such that the outer surface 11 and inner surface 12 are each curved. The windshield 10 may be fixedly attached within the opening in the vehicle frame 40, or may be connected to the vehicle frame 40 using lift arms that allow the windshield 10 to be opened into a raised position as shown in FIGS. 6 and 7 or closed to a lowered position as shown in FIGS. 5 and 8.

### Frame 20

As shown in FIGS. 1-10, a frame 20 attaches to the windshield 10. The frame 20 protects the windshield 10 from damage that may occur, for example, from objects contacting the windshield 10 at or near its perimeter when the windshield 10 is in a raised position or when the vehicle encounters rough terrain during operation.

The frame 20 may comprise a sheet or panel of material that engages and overlaps the windshield 10. In one embodiment, the frame 20 may be made from metal such as stainless steel; alternatively, the frame 20 may be made from another suitable material without departing from the scope of the disclosure. The frame 20 may alternatively be referred to as protective frame 20 or metal frame 20 without departing from the scope of the disclosure.

As illustrated the frame 20 can have a generally rectangular shape and is defined by a top wall 23 and an opposing bottom wall 24 that is generally parallel to the top wall 23, a first side wall 26 that is generally perpendicular to the top wall 23 and bottom wall 24, and a second side wall 27 that opposes and is generally parallel to the first side wall 26 and is generally perpendicular to the top wall 23 and the bottom wall 24. The top wall 23, bottom wall 24, first side wall 26, and second side wall 27 are continuous and seamless so as to form an uninterrupted inner surface 22 and outer surface 21. The inner edges of the top wall 23, bottom wall 24, first side wall 26, and second side wall 27 form an uninterrupted inner edge of the frame 20 that defines the opening 28 as well as the inner perimeter of the frame 20. The outer edges of the top wall 23, bottom wall 24, first side wall 26, and second side wall 27 form an uninterrupted outer edge that defines the outer perimeter of the frame 20. The corners of the opening 28, defined where the inner edges of walls 21, 22, 26, and 27 join one another, can be curved corners that have a degree of curvature, or the corners can alternatively be formed at right angles or another suitable shape.

In order to engage and protect the windshield 10, the shape of the frame 20 matches the shape of the windshield 10 in both its overall profile (e.g., generally rectangular, generally trapezoidal, or another shape) and curvature. If the windshield 10 is flat, then the frame similarly will be flat. If the windshield 10 is curved, then the frame 20 will have a curvature that matches the curvature of the windshield 10. The shape formed by the outer perimeter of the frame 20 generally matches the shape of the windshield 10, allowing the windshield 10 to be closed without interference between the protective assembly 1 and the vehicle frame 40 or other parts of the vehicle. In one embodiment, each edge of the outer perimeter of the frame 20 aligns with the corresponding outer edge of the windshield 10, giving the frame 20 and the windshield 10 the same outer perimeter. In another embodiment, the outer perimeter of the frame 20 may be scaled such that the outer perimeter of the frame 20 is slightly larger than the perimeter of the windshield 10. In the latter embodiment, the outer edge or outer perimeter of the frame 20 extends slightly beyond the edge or perimeter of the windshield 10, forming a protrusion 25. Scaling the perimeter of the frame 20 to create a protrusion 25 allows additional protection for windshield 10 as objects that would normally strike the edge or perimeter of the windshield 10 are blocked from contacting the windshield 10 by the protrusion 25. In one embodiment, the protrusion 25 may be sized such that the outer edge or outer perimeter of the frame 20 extends beyond the edge or perimeter of the windshield 10 by ¼ inch. Other protrusion 25 sizes may be used; however, the protrusion 25 must be large enough to provide protection to windshield 10, yet small enough to avoid interference between the frame 20 and the vehicle frame 40.

In another embodiment, the frame 20 positively engages the vehicle frame 40 using male and female pins with one set of male and female pins placed at each corner of the frame 20. By doing so, the torsional strength of the vehicle is increased by making the glass of the windshield 10 a stressed member of the vehicle frame 40.

The frame 20 has an outer surface 21 comprising the area of the frame 20 that faces the exterior of the vehicle and an inner surface 22 comprising the area of the frame 20 that faces the interior of the vehicle. The outer surface 21 of the frame 20 engages the inner surface 12 of the windshield 10. In one embodiment, the frame 20 may be adhered to the windshield 10 using an adhesive 50 such as a urethane adhesive; however, other suitable attachment means may be used without departing from the scope of the disclosure. In addition to securing the frame 20 to the windshield 10, the adhesive 50 separates the frame 20 from the windshield 10. One or more spacers may be inserted between the windshield 10 and the frame 20. If used, the spacers are used in conjunction with the adhesive 50 to separate the frame 20 from the windshield 10. In one embodiment, the spacers may be plastic; however, other suitable materials may be used. The inner surface 22 of the frame 20 engages the gasket 30. In one embodiment, the frame 20 may be adhered to the gasket 30 using an adhesive 60; however, other suitable attachment means may be used without departing from the scope of the disclosure.

### Gasket 30

As shown in FIGS. 1-10, a gasket 30 may attach to the frame 20 and engage the windshield 10. The gasket 30 provides cushioning and further protection to the windshield 10 from damage that may occur, for example, from objects contacting the windshield 10 at or near its perimeter when the windshield 10 is in a raised position or when the vehicle encounters rough terrain during operation. The gasket 30 separates the windshield 10 from the vehicle frame 40. The gasket 30 also engages the vehicle frame 40 snugly to form a seal that prevents wind, water, debris, etc. from entering the vehicle through the gap between the windshield 10 and the vehicle frame 40.

The gasket 30 may comprise a continuous length of an elastomeric material such as rubber that attaches to the frame 20 and overlaps the windshield 10. The gasket 30 extends around the windshield 10 and the frame 20, covering the outer edge or perimeter of both the windshield 10 and the frame 20.

As can be seen in FIG. 1, the gasket 30 may comprise an enlarged section 31 extending between the inner surface 22 of the frame 22 and the inner extent of the gasket 30 which engages the vehicle frame 40. The enlarged section 31 is the innermost portion of the gasket 30. The enlarged section 31 of the gasket 30 provides cushioning between the inner surface 22 of the frame 20 and the vehicle frame 40. The enlarged section 31 of the gasket 30 attaches to the inner surface 22 of the frame 20 using an adhesive or another suitable attachment means. The enlarged section 31 may comprise a hollow tube of the gasket 30 material, allowing the enlarged section 31 to compress enough for the windshield 10 to be closed. The enlarged section 31 may further comprise a vehicle engaging member 32, also made of the gasket 30 material, which extends between the outside edge of the gasket 30 and the edge of the vehicle frame 40 that is adjacent to the edge or perimeter of the windshield 10.

The gasket 30 may also comprise a recess 33 for accommodating the edge or perimeter of the frame 20. The recess 33 may comprise a groove formed in the inner edge of the gasket 30 adjacent to edge or perimeter of the frame 20.

The gasket 30 may also comprise a cap 34 for covering the gap formed between the windshield 10 and the vehicle frame 40. The cap is the outermost portion of the gasket 30, and extends between the recess 33 and the outer extent of the gasket 30. The inner edge of the cap 34 extends inwardly to engage and overlap the outer surface 11 of the windshield 10. The outer edge of the cap 34 extends outwardly to engage and overlap the vehicle frame 40.

For a windshield 10 that can be raised to an open position or lowered to a closed position by pivoting around one or more hinges at the top of the windshield and clamping closed using a clamping handle, the clamping handle typically rotates ninety degrees and pulls the protective assembly 1 tight to the vehicle frame 30, thereby compressing the gasket 30.

The protective assembly 1 as shown and described includes the gasket 30; however, the gasket 30 may be omitted without departing from the scope of the disclosure.

### Method of Manufacture 100

As shown in FIG. 11, a method for manufacturing a protective assembly 1 for a windshield 10 begins at step 110 with providing a windshield 10. The windshield 10 may be as previously described in the section titled “Windshield 10.”

At step 120, a frame 20 is provided. The frame 20 may be as previously described in the section titled “Frame 20.” Providing a frame 20 at step 120 may involve manufacturing the frame 20. Frame 20 may be formed from a single piece of material, such as a metal panel or sheet. The outer perimeter of the frame 20 is cut from the piece of frame 20 material. The outer perimeter of the frame 20 and the opening 28 may be formed in the frame 20 by machining, laser cutting, or any other suitable method for forming an opening 28 in the frame 20. The edges of the inner perimeter created through the formation of the opening 28 and the edges of the outer perimeter of the frame 20 may be smoothed such as by sanding, deburring, polishing, or the like. The frame may be pressed or otherwise shaped to match a curvature of the windshield 10 provided at step 120. The frame 20 may be painted, powder coated, or otherwise treated for the purpose of prolonging the useful life of the frame 20 and protective assembly 1 as a whole, or for aesthetic purposes.

At step 130, a gasket 30 is provided. The gasket 30 may be as previously described in the section titled “Gasket 30.” Providing a gasket 30 at step 130 may involve manufacturing the gasket 30. The gasket 30 may be formed by extruding a length of gasket 30 material to achieve the desired gasket 30 shape and cutting a length of the gasket 30 material corresponding to the outer perimeter of the frame 20.

The method 100 proceeds to step 140 in which the frame 20 is attached to the windshield 10. The frame 20 may be attached to the windshield 10 as previously described in the section titled “Frame 20.” As previously described, in one embodiment, the outer surface 21 of the frame 20 engages the inner surface 12 of the windshield 10. The frame 20 may be adhered to the windshield 10 using an adhesive 50; however, other suitable attachment means may be used without departing from the scope of the disclosure. One or more spacers may be inserted between the windshield 10 and the frame 20. In one embodiment, the spacers may be plastic; however, other suitable materials may be used.

The method 100 proceeds to step 150 in which the gasket 30 is attached to the frame 20. The gasket 30 may be attached to the frame 20 as previously described in the section titled “Frame 20.” As previously described, in one embodiment, The inner surface 22 of the frame 20 engages the gasket 30. In one embodiment, the frame 20 may be adhered to the gasket 30 using an adhesive 60; however, other suitable attachment means may be used without departing from the scope of the disclosure. The cut ends of the gasket 30 may be adhered or fused together such that the gasket 30 completely surrounds the windshield 10 and frame 20 without a gap. Alternatively, the cut ends of the gasket 30 may abut each other without being connected to each other. The gasket 30 may be adjusted as needed such that the protrusion 25 of the frame 20 fits snugly within the recess 33 in the gasket 30, and such that the inner edge of the cap 34 engages and overlaps the outer surface 11 of the windshield 10 and the outer edge of the cap 34 engages and overlaps the vehicle frame 40.

While the method 100 as shown and described includes the steps of providing a gasket 30 at step 130 and attaching the gasket at step 150, these steps may be omitted, thus omitting the gasket 30 from the protective assembly 1, without departing from the scope of the disclosure.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A protective assembly for a windshield comprising:
a protective assembly frame wherein the protective assembly frame comprises a top wall, a bottom wall, a first side wall, and a second side wall that define an opening in the protective assembly frame, the protective assembly frame further comprising an inner surface and an outer surface wherein the outer surface of the protective assembly frame is attached to an inner surface of the windshield.

2. The protective assembly of claim 1 wherein the top wall, bottom wall, first side wall, and second side wall are continuous such that the inner surface and outer surface of the protective assembly frame are seamless.

3. The protective assembly of claim 1 wherein the outer surface of the protective assembly frame is attached to the inner surface of the windshield using an adhesive.

4. The protective assembly of claim 1 wherein the outer perimeter of the windshield aligns with the outer perimeter of the protective assembly frame.

5. The protective assembly of claim 1 wherein the outer perimeter of the protective assembly frame extends beyond the outer perimeter of the windshield.

6. The protective assembly of claim 1 further comprising a rubber gasket attached to the protective assembly frame such that the rubber gasket extends around an outer perimeter of the protective assembly frame and an outer perimeter of the windshield, the rubber gasket comprising a cap configured to overlap both the windshield and a frame of a vehicle on which the windshield is installed.

7. The protective assembly of claim 6 wherein the rubber gasket attaches to the inner surface of the protective assembly frame.

8. The protective assembly of claim 7 wherein the rubber gasket attaches to the inner surface of the protective assembly frame using an adhesive.

9. The protective assembly of claim 6 wherein the rubber gasket comprises an enlarged section extending between the inner surface of the protective assembly frame and an inner extent of the rubber gasket which engages the frame of the vehicle.

10. The protective assembly of claim 9 wherein the enlarged section further comprises a vehicle engaging member extending between an outside edge of the enlarged section and an edge of the frame of the vehicle that is adjacent to the outer perimeter of the windshield.

11. A method of making a protective assembly for a windshield comprising:
providing a windshield comprising an inner surface and an outer surface;
providing a protective assembly frame, the protective assembly frame comprising a top wall, a bottom wall, a first side wall, and a second side wall that define an opening in the protective assembly frame, the protective assembly frame further comprising an inner surface and an outer surface; and
attaching the outer surface of the protective assembly frame to the inner surface of the windshield.

12. The method of claim 11 further comprising providing a rubber gasket, the rubber gasket comprising a cap configured to overlap both the windshield and a frame of a vehicle on which the windshield is installed; and attaching the rubber gasket to the inner surface of the protective assembly frame such that the gasket extends around an outer perimeter of the protective assembly frame and an outer perimeter of the windshield.
